(19) United States
(12) Patent Application Publication
(10) Pub. No.: US 2012/0171011 A1
(43) Pub. Date: Jul. 5, 2012

(54) WIND TURBINE-TYPE DEVICE

(75) Inventor: Arthur Iwanow, Jork (DE)

(73) Assignee: Roza Barczak, Jork (DE)

(21) Appl. No.: 13/394,998

(22) PCT Filed: Sep. 8, 2010
(86) PCT No.: PCT/DE10/01056

§ 371 Date: Mar. 8, 2012

(30) Foreign Application Priority Data
Sep. 8, 2009 (DE) 10 2009 040 467.8

(51) Int. Cl. F03D 7/06

(52) U.S. Cl. 415/4.2

(57) ABSTRACT

The invention relates to a wind turbine-type device for utilizing the energy contained in an air flow. Said device is equipped with a rotating cylinder (2a) with rotating vanes (2), a stationary guiding cylinder (4a) surrounding the rotating cylinder (2a), said guiding cylinder having guiding blades (2) and capturing vanes (5) which are directed onto the guiding blades (4), the capturing vanes (5), in the direction of the oncoming air (A), are staggered from front to back from capturing vane (5) to capturing vane (5) to end in a laterally projecting manner so that the capturing vanes (5) capture subflows (5,12 to 5,56) of the oncoming air flow associated therewith and deviate them towards the guiding blades (4).

The invention relates to a wind turbine-type device for utilizing the energy contained in an air flow, which is equipped with an internal rotating cylinder, which has rotating vanes supplied with air and serves to drive the power generator.

Such devices are known. DE 19623055 A1 describes a wind power plant with an internal rotating cylinder with rotating vanes, which is surrounded by an external stationary guiding cylinder with guiding blades. The wind power plant is positioned into the wind such that the oncoming air flow hits the guiding blades diagonally to the rotor axis. These guide the oncoming air to the rotating vanes of the rotating cylinder and set it in motion. The purpose of the guiding blades surrounding the guiding vanes of the rotating cylinder is to guide the air to the rotating vanes at the most constant possible air flow angle.

In the case of the known devices, all air that does not directly hit the even cylinder curvature flows off unused.

The object of the invention is to improve a device of the known type such that the air flow oncoming laterally of the cylinder curvature, which up until now flows away laterally unused, is also used to drive the rotating cylinders. If possible, air oncoming even in the shadow behind the turbine arrangement should thereby be captured.

The set object is achieved according to the invention with two embodiment variants, as described in greater detail in the independent claims. Preferred embodiments are the subject of the dependent claims or are described below.

The first embodiment variant comprises a wind turbine-type device for utilizing the energy contained in an air flow, with a cylindrical wind turbine, which is equipped
with an internal rotating cylinder, which has rotating vanes supplied with air and in particular serves to drive a circumferential power generator, wherein the rotating vanes can also have a helical shape, in order to also be better able to divert air above or respectively below the rotor axis;
with a stationary guiding cylinder surrounding the rotating cylinder, which has stationary guiding blades, which guide the air flow fed to them to the rotating vanes of the rotating cylinder; and
   with capturing vanes, which are directed outside the guiding blades of the stationary guiding cylinder onto its guiding blades,
   wherein the capturing vanes belong to a pivoting cylinder, with which they are pivotable into an optimal capturing position, preferably at least partially against the oncoming air flow;
   wherein the capturing vanes, in the direction of the oncoming air, are staggered from front to back and hereby end in a more laterally projecting manner from capturing vane to capturing vane so that the capturing vanes capture subflows of the oncoming air flow associated therewith and deviate them towards the guiding blades and
   wherein the capturing vanes on both sides of the cylinder curvature flowed against by the air flow preferably experience the same alignments with respect to the air flow or different.

If the rotating vanes have a helical shape, the helix can be mirrored e.g. in the area of the middle of the rotor axis on a mirror plane at a 90° angle to the rotor axis in order to also divert the wind (proportionately) in both directions of the axis, upwards and downwards in the case of the first vertical embodiment and to both sides according to the second horizontal embodiment.

According to one embodiment, the distance between the capturing vane ends from capturing vane to capturing vane is calculated with the help of parallel lines to the approach direction through the capturing vane tips smaller from front to back, with the exception of the final capturing vane.

This embodiment is primarily provided for operation with a vertically positioned axis. The air oncoming laterally of the wind turbine is also captured by the capturing vanes arranged further back in the approach direction and projecting further and further and is fed to the rotating vanes of the rotating cylinder. The wind is thus better utilized.

It is provided according to a further design of the invention that—as seen from the approach direction—even more elongated final capturing vanes are located behind the capturing vanes, which with their projecting end edges are located the furthest behind, preferably at least partially in the wind shadow behind the full guiding cylinder width, where the guiding cylinder width in the curvature becomes smaller again, in terms of area and elongation. These final capturing vanes ensure further capturing of laterally flowing air.

According to one embodiment, at least one, and in the case of a symmetrical design both, of the forward-projecting tips of a final capturing vane project over the approached transverse axis, which runs through the rotor axis and is positioned at a right angle to the wind direction, while a total of at least two subsequent capturing vanes preferably do not do this.

The final capturing vanes each have in particular forward-projecting tips (i.e. against the direction of the wind), the tip(s) of which project over the tip of the respective next capturing vane, if applicable even over that of the second next capturing vane towards the front.

The final capturing vanes have in particular capturing vane angles (angles between line 1 and 2), respectively in relation to a line segment from outer end edge of the capturing vane to the inner end edge (line 1) of the capturing vane and inner end edge of the capturing vane to the rotor axis (line 2) of preferably 70 to 90°, in the case of an asymmetrical construction of 60 to 90° on the one side and 100 to 135° on the other side, while the immediately following capturing vane, if applicable also the immediately following and the next following capturing vane, have capturing vane angles between 115 to 160°, in the case of an asymmetrical construction on the one side from 80 to 135° (on the capturing side) and on the other side from 135 to 180° (on the non-capturing side). In the case of an asymmetrical construction, the capturing vanes are longer on average on the capturing side of the rotating vanes.

The capturing side is the side of the device, where the direction of rotation of the rotating vanes corresponds with the wind direction. The non-capturing side of the capturing vanes is the side of the device where the direction of rotation of the rotating vanes runs against the wind direction.

The further the capturing vanes and the final capturing vanes are arranged over the largest lateral elongation of the guiding cylinder in the wind shadow towards the back, that is in the case of a guiding cylinder width becoming smaller again, the larger the captured air quantity. The construction should thus be designed such that the captured air is distributed as evenly as possible across all approached guiding blades.

It is provided according to a further design of the invention that—seen in the approach direction—the inner end edges of the final capturing vanes are located approximately at a width angle of the guiding cylinder of 250 to 350° or the final capturing vanes are even aligned parallel to each other.

It is provided according to a further embodiment that the final capturing vanes are provided with aligning surfaces bent outwards on their outsides, whereby the final capturing vanes take over the function of an aligning vane. A special aligning vane can be omitted according to one design. However, one or more aligning vanes have generally proven to be advantageous.

According to a further design of the invention, air deflectors are provided, which protect the area above and, if applicable, also below the device (above and, if applicable, also below the rotor axis) like a kind of a cap open to the side facing away from the wind, wherein the cap aligns itself with the wind, e.g. in that it is carried along by the wind capturing vanes.

The second embodiment variant comprises a cylindrical wind turbine-type device for utilizing the energy contained in an air flow, which is equipped
with an internal rotating cylinder, which has rotating vanes supplied with air and in particular serves to drive a power generator drivable via the rotor axis,
with a stationary guiding cylinder surrounding the rotating cylinder, with guiding blades, which guide the air flow fed to them to the rotating vanes of the rotating cylinder,
with stationary capturing vanes, which are directed towards the guiding blades outside the guiding blades of the stationary guiding cylinder,

wherein the capturing vanes in the approach direction are staggered from front to back and end in a more laterally projecting manner from vane to vane and are designed in a stationary manner,
with at least one pivotable air guiding comb, which pivots above or below, or respectively two air guiding combs, which pivot above and below the capturing vanes, respectively relative to the horizontal axis of rotation, in the area of the largest cylinder curvature in the approach direction in the case of increasing pressure of the oncoming air flow further back in the approach direction, i.e. with the air flow,
wherein the capturing vanes have the same alignments with respect to the air flow if applicable on both sides of the cylinder curvature approached by the air flow.

This embodiment variant is provided in particular for operation with an almost horizontally running axis; it is suitable for installation on a roof ridge. In this case as well, the air approaching laterally of the wind turbine is captured by the capturing vanes located further back in the approach direction and is directed over the guiding blades to the rotating vanes of the rotating cylinder. The wind is better utilized.

It is provided according to a further design of the invention that the capturing vanes have a constant projection in the area covered by the air guiding combs. An air loss between the capturing vanes and the air guiding combs is thus prevented.

It is provided according to a further embodiment of the invention that the air guiding combs are designed such that they in the case of a low approaching air flow automatically pivot back into a vertical position by means of return mechanisms and in the case of an air flow that is becoming stronger pivot towards the back in that they are pushed by the air flow. The return mechanisms can be realized with a spring balancing device or just with counterweights.

It is provided according to a further design of the invention that the maximum deviation of the air guiding combs towards the back is measured at 220 to 300°. In this case as well, air that hits them in the wind shadow in the area of the guiding cylinder width that is becoming smaller again can still be captured.

It is provided according to a further design of the invention that, at approximately half the length of the cylindrical wind turbine, a collar extends around it. With this collar, the oncoming air, which does not hit exactly diagonally but rather at an angle to the axis of the wind turbine, is captured as best as possible and utilized for drive.

It is provided according to a further design of the invention that the outer collar edge and the outer lying edges of the air guiding combs are provided at the same distance from the turbine axis.

It is provided according to a further design of the invention that the cross-section of the collar corresponds with the cross-section of a drop, the tip of which points towards the rotor axis. The collar has an acceleration function for the air hitting it and thus further improves its entering into the rotating cylinder.

It is provided according to a further design of the invention that a stationary, roof-like air capturing comb is provided above the upper air guiding comb. This air capturing comb captures the air collected between it and the air guiding combs and diverts it into the guiding cylinder and the rotating cylinder.

It is provided according to a further design of the invention that end covers are located on the head sides of the wind turbine, which are provided with sloped slits in the direction of the rotating direction of the rotating cylinder, which extend between the rotor axis (3) and the outer edge of the turbine. These slits also serve to collect a diagonally oncoming air flow and to direct it to the rotor cylinder.

It is provided according to a further design of the invention that air flowing in through the slits from the head side hits the guiding blades and the first third of the rotating vanes, wherein the full admission of the air to the rotating vanes is inhibited by means of a check plate covering the rotating cylinder.

It is provided according to a further design of the invention that a connection line between the outer end edges and the inner end edges of the rotating vanes of the rotating cylinder, which the approaching air hits, with the connection line to the rotor axis includes angles between c1 equaling −20° and c2 equaling +30°. This means that the inner end edge can be pivoted to an angle c1 becoming 0 c1 up to the middle line, where it falls on the middle line. However, the inner end edges with increasing angle c2 can be placed further to the right to an end edge point on the connection line pivoted to the right.

The inner neighboring end edges of the rotating vanes—seen from the rotor axis 3—lie apart at an angle d between 5° to 35°.

The outer end surfaces of the guiding blades with the intended connection line to the rotor axis include angles between el equaling −30° and e2 equaling +65°.

The inner lying air outlet edges of the guiding blades—seen from the rotor axis—lie apart at an angle f from 5° to 35°.

The inner lying air outlet edges and the outer lying air inlet edges of the capturing vanes—measured from the rotor axis—lie apart at an angle h from 5° to 35°.

It is provided according to a further design of the invention that it is designed as a module for multiple arrangements in a row. The modules are thereby provided with their own generator in blocks.

It is provided according to a further design of the invention that an interconnected block consists of 4 to 6 modules, which are set to their own generator.

As the height increases, the flow conditions of the air also change. By combining several modules into blocks, economical operation can be achieved.

The invention is explained in greater detail based on the drawing. In the figures:

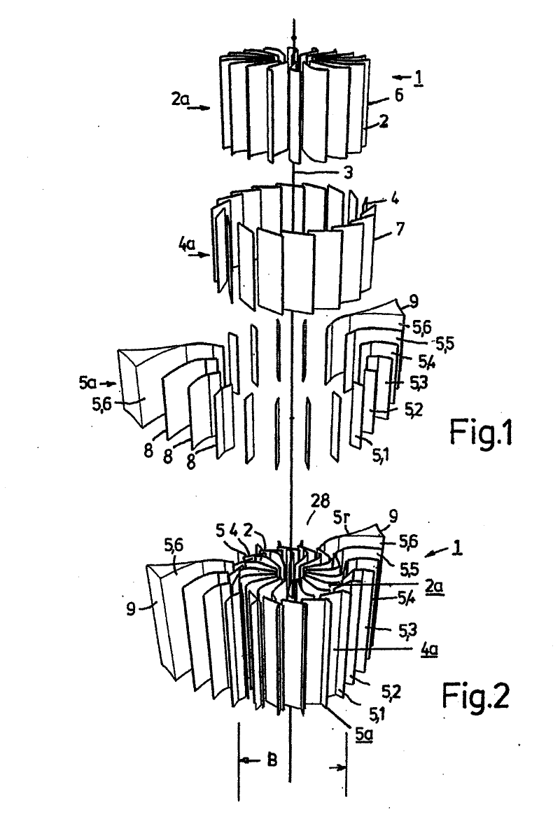

FIG. 1 shows a diagramed exploded view of the structure of a first embodiment variant of a device according to the invention for utilizing the energy contained in an air flow with three air guiding cylinders arranged above each other around a vertical axis, which are subdivided into an inner, circumferential rotating cylinder, consisting of rotating vanes, a stationary guiding cylinder surrounding the rotating cylinder, consisting of guiding blades, and a capturing cylinder designed as a pivoting unit surrounding the guiding blades of the guiding cylinder, consisting of capturing vanes that can be directed into the wind, which in the approach direction are staggered from front to back and end in a more laterally projecting manner from vane to vane so that the capturing vanes capture subflows of the oncoming air flow associated therewith and feed them to the rotating vanes via the guiding blades,

FIG. 2 shows a diagram set inside each other of the three air guiding cylinders shown above each other in FIG. 1 with the inner rotating vanes, with the guiding blades arranged around them and with the capturing vanes in turn arranged around them,

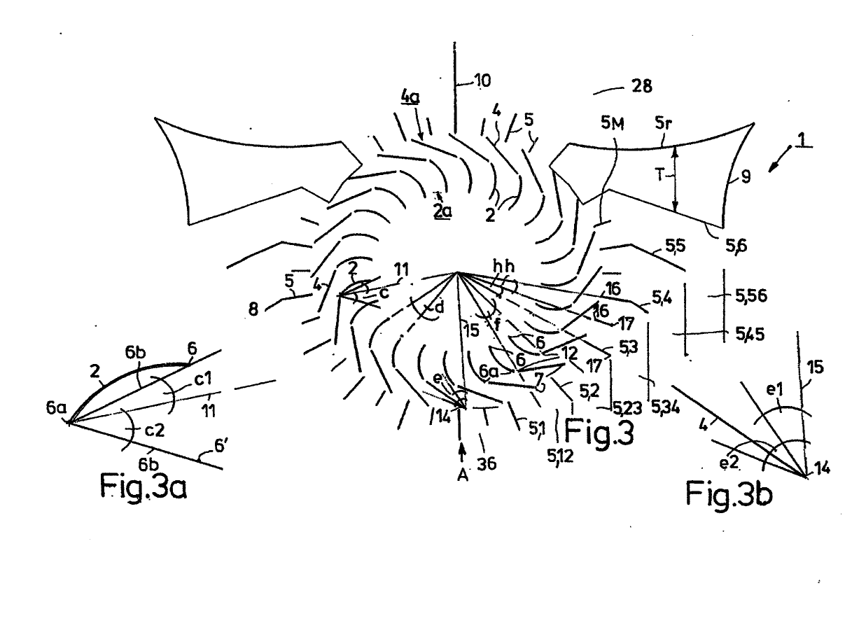

FIG. 3 shows a top view of the arrangement according to FIG. 2 with the air guiding cylinders set inside each other and the rotating cylinder,

FIG. 3a shows an enlarged view pulled out of FIG. 3 of potential angle positions of the inner lying rotating vane edges opposite the radial lines to the rotor axis,

FIG. 3b shows an enlarged view pulled out of FIG. 3 of potential angle positions of the guiding blades opposite the radial lines to the rotor axis,

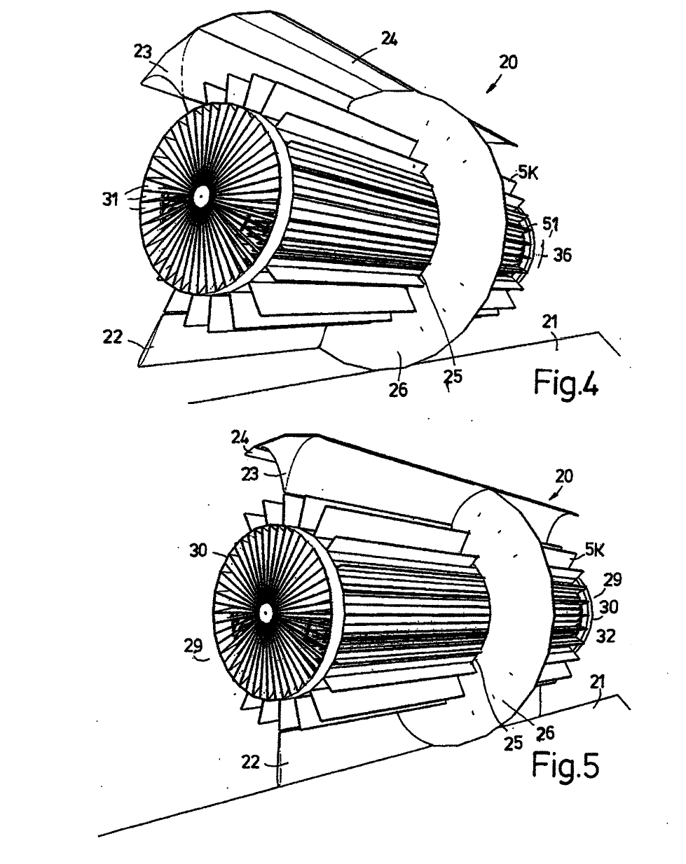

FIG. 4 shows a diagram of the structure of a second embodiment variant of the device according to the invention as a cylindrical wind turbine-type device for utilizing the energy contained in an air flow with a horizontal axis, which is structured in multiple parts from: an inner, circumferential rotating cylinder with rotating vanes, which convert the energy of the air flow into rotational energy, which rotates a generator shaft, a stationary guiding cylinder surrounding the rotating cylinder with guiding blades and a stationary capturing cylinder surrounding the stationary guiding cylinder, which in the approach direction are staggered from front to back and end in a more laterally projecting manner from capturing vane to capturing vane so that the capturing vanes capture subflows of the oncoming air flow associated therewith and feed them to the rotating vanes via the guiding blades, and with air guiding combs which can partially pivot in the oncoming air when positioned pivoted away from the wind,

FIG. 5 shows a diagram of the structure according to FIG. 4 with the air guiding combs in a middle position in low wind,

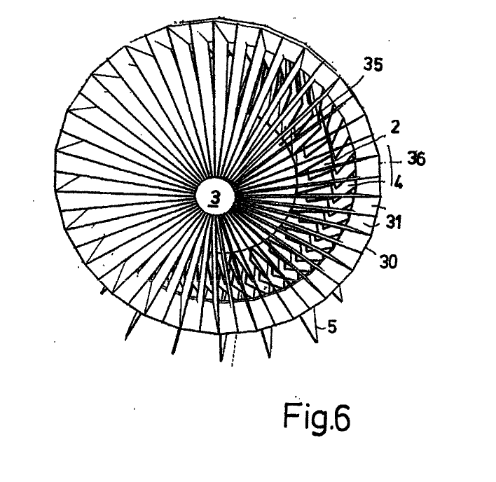

FIG. 6 shows a diagram of a lateral end cover of the device according to FIGS. 4 and 5,

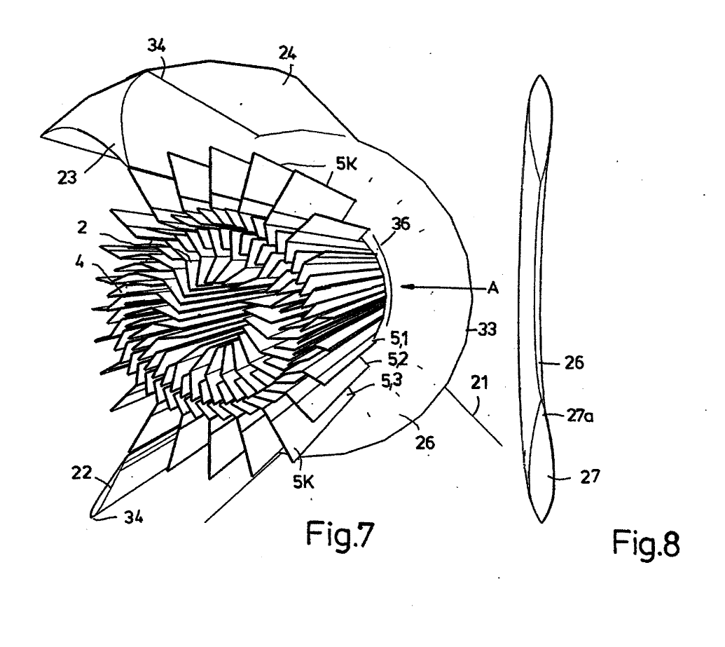

FIG. 7 shows a diagram of the device according to FIGS. 4 and 5 with the end cover removed,

FIG. 8 shows a cut through a collar, which extends in the axial middle around the wind turbine,

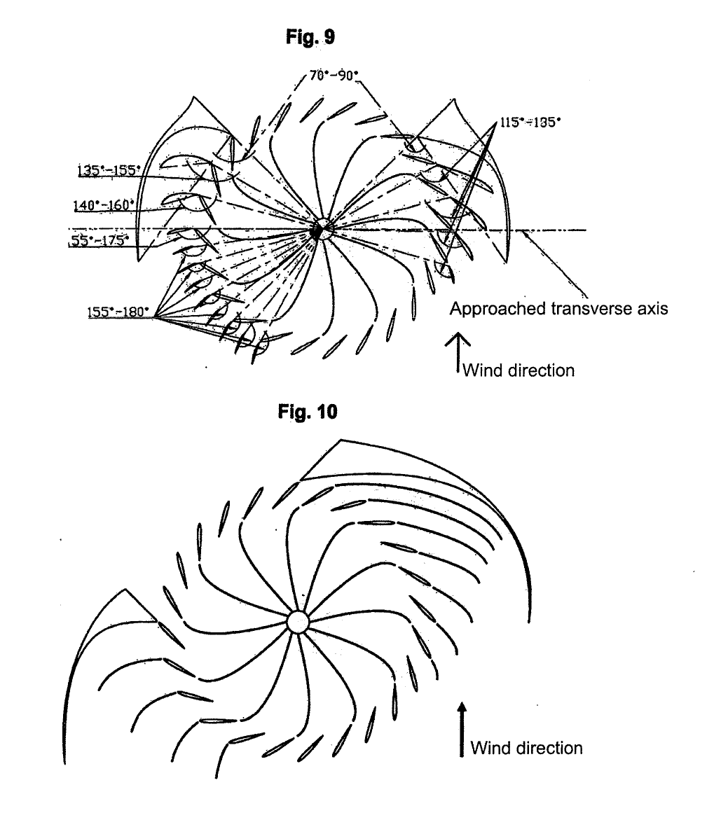

FIG. 9 shows a diagram of suitable angle areas of the capturing vane angles (angle between line 1 and 2) of embodiment 1, respectively in relation to a line segment from outer end edge of the capturing vane to the inner end edge (line 1) of the capturing vane and inner end edge of the capturing vane to the rotor axis (line 2), wherein the capturing vanes are structured mainly symmetrically, and

FIG. 10 shows an asymmetrical construction of the capturing vanes, with different average capturing vane lengths on both sides.

The device according to the invention is realized with two operating forms of wind turbines shown in the drawings.

The first variant 1 of the devices according to the invention is shown in FIG. 1 through 3 for operation in a vertical axial position. FIG. 1 shows the construction based on air guiding cylinders and namely rotating cylinder 2a, guiding cylinder 4a and capturing cylinder 5a, which are shown diagramed in an exploded view above each other. For clarity, only the rotating vanes 2, the guiding blades 4 and the capturing vanes 5 are shown for cylinders 2a, 4a and 5a.

All air guiding cylinders 2a, 4a and 5a are grouped around the rotor axis 3 of the device. The guiding blades 4 associated with the guiding cylinder 4a are shown below the rotating vanes 2 of the rotating cylinder 2a shown above.

The capturing cylinder 5a with capturing vanes 5 is shown again with a larger diameter under the guiding blades 4 associated with the guiding cylinder 4a. This capturing cylinder with its capturing vanes 5 has one distinctive feature: it is pivotable and aligns itself in the oncoming air flow such that the capturing vanes 5 on both sides of the rotor axis 3 set themselves to the same position against the air flow.

While the outer edges 6a of all rotating vanes 2 on one hand and the outer edges 7 of all guiding blades 4 on the other hand in sets all have the same distances from the rotor axis 3, the outer end edges 8 of the capturing vanes 5 all have different distances of the rotor axis 3. Namely, the capturing vanes 5 end staggered in the approach direction from front to back and project further laterally from capturing vane 5,1 to capturing vane 5,2 etc. so that capturing vanes 5 capture subflows 5,12, 5,23 etc. of the oncoming air flow associated therewith and divert them to the guiding blades 4 and rotating vanes 2. The subflows are described more clearly in FIG. 3.

In FIG. 2, the air guiding cylinders 2a, 4a and 5a are pushed into each other. It can be seen that—seen in the approach direction—even more elongated final capturing vanes 5,6 are located behind the capturing vanes 5,5 in the wind shadow behind the full turbine width B, where the turbine width in the curvature becomes smaller again, in terms of area and elongation. These final capturing vanes 5,6 are provided on their outsides with outwardly bent aligning surfaces 9, whereby the final capturing vanes 5,6 take on the function of an aligning vane. The final capturing vanes 5,6 are located—seen from the approach side A (FIG. 3)—approximately at a width angle of the guiding cylinder of approximately +/−270 angle degrees. An aligning vane 10 can be present or omitted.

The final capturing vanes 5,6 have a greater depth T in approach direction A so that the aligning surfaces 9 in approach direction A do not end free but are rather incorporated into the final capturing vanes 5,6. The back sides 5r are curved inward such that they facilitate a negative pressure formation on the back side 28 of the device 1. Negative pressure on the back side 28 accelerates the flowing away of the air and thus simultaneously a better air flow rate.

FIG. 3 shows a top view of variant 1 of the device. The rotating vanes 2 of the rotating cylinder 2a can be seen on the inside. The guiding vanes 4 of the guiding cylinder 4a are grouping around it. Capturing vanes 5 of capturing cylinder 5a are grouped in turn around it.

The outer end edges 8 of the capturing vanes 5 always project from approach side A to the right and left more laterally staggered from front to back from capturing vane 5 to capturing vane 5 so that the capturing vanes 5 capture the subflows 5,12; 5,23; 5,34; 5,45; 5,56 of the oncoming airflow associated therewith and divert them to the guiding blades 4 and the guiding vanes 2. The width of the subflows 5,12 through 5,56 can be changed for an optimal utilization of the air flow. Capturing vanes 5M are provided between the capturing vanes 5 lengthening from capturing vane 5 to capturing vane 5, which do not lengthen continuously. Shorter and longer capturing vanes 5 and 5M alternate.

The capturing vanes 5,4; 5,5; 5,6 continuously lengthening from capturing vane 5 to capturing vane 5 are partially bent against approach direction A in order to better capture air.

This separation and guiding of subflows applies to both variants of the device according to the invention.

The shapes of the rotating vanes and their arrangement with respect to each other are significant for all turbines. For the wind turbine according to the invention, and namely in both variants, special angle positions are thus preferred. FIG. 3a shows an enlarged view of the angle positions for the rotating vanes 2. A connection line 6b between the outer end edges 6a and inner end edges 6 of the rotating vanes 2 of the rotating cylinder 2a, where the oncoming air hits, includes with the connection line 11 to rotor axis 3 angles between c1 equaling −20° and c2 equaling +30°.

This means that the inner end edge 6 can be pivoted up to an angle c1 becoming 0 up to middle line 11, where it falls on the middle line 11. However, the inner end edge 6 with increasing angle c2 can be placed even further right to an end edge point 6′ on the connection line 6b pivoted further to the right.

The inner neighboring end edges 6 of the rotating vanes 2 lie apart—seen from rotor axis 3—at an angle d between 5° and 35°.

As the enlarged view according to FIG. 3b shows, the outer end surfaces 14 of the guiding blades 4 with the intended connection line 15 to rotor axis 3 includes angles between el equaling −30° and e2 equaling −65°.

The inner lying air outlet edges 12 of the guiding blades 4 lie apart—seen from rotor axis 3—at an angle f from 5° to 35°.

The inner lying air outlet edges 16 and the outer lying air inlet edges 17 of capturing vanes 5 lie apart—measured from rotor axis 3—at an angle h from 5° to 35°.

FIG. 4 through 8 show the second variant 20 of the wind turbine according to the invention. The rotor cylinder 2a with its rotating vanes 2 and the guiding cylinder 4a with its guiding blades 4 correspond to those in FIG. 1 through 3. Variant 20 of the wind turbine according to the invention is cylindrical and is designed for operation with a horizontal rotor axis 3. It is primarily suitable for operation on a roof ridge 21. Different from the first variant according to FIG. 1 through 3 is the construction of the air capturing device grouping itself around the guiding cylinder, consisting of the capturing vanes 5, air guiding combs 22 and 23, an air capturing comb 24 and a collar 26 extending around the middle 25 of the cylindrical wind turbine. The capturing vanes 5 have in the at first blown-at approach direction A, where the air first hits the wind turbine 20, increasing vane lengths as in the variant according to FIG. 1 through 3. The outer end edges 8 of the capturing vanes 5 thereby have different distances from the rotor axis 3. The capturing vanes 5 end projecting further laterally in the approach direction staggered from front to back from capturing vane 5,1 to capturing vanes 5,2, 5,3.

On the top and bottom, the capturing vanes 5K have the same length and end at the same distance from the rotor axis 3. The plate-like air capturing combs 22 and 23 are arranged in a pivotable manner around the rotor axis 3; they set themselves in vertical positions that are unloaded or only slightly impacted by the air flow. This can be seen in FIG. 5. The return mechanisms can work with spring compensation or counterweights. When the approaching air increases, they move back, as shown in FIGS. 4 and 7. The largest pivot or wrap angle is approximately +/−240 angle degrees as seen from the front. FIG. 7 shows that the air capturing combs 22 and 23 run past the capturing vanes 5K when pivoted with a small distance.

The oncoming air flow hits the cylinder curvature 36 of the wind turbine 20 from below over the roof ridge 21. The air capturing comb 22 thereby supports the introduction of the air into the guiding cylinder 4a and the rotating cylinder 2a. On the top, the air flow is captured by the air capturing comb 23 and the upper air guiding comb 24. During pivoting, the air capturing comb 23 runs along below the roof-shaped air guiding comb 24.

It can be that the air does not hit more or less diagonal to the axial position of the device but rather sloped. In order to also be able to capture as much air as possible in this case, the collar 26 is provided in the middle 25 of the wind turbine 20. As can be seen in FIG. 8, the collar 26 in cross-section 27 has the shape of a drop with the tip 27a towards rotor axis 3. When the air hits the wind turbine 20 in a sloped manner, the collar 26 captures the portion of air approaching in front of the collar 26. The drop-like cross-section 27 feeds the air to the cylinders 4a and 2a while accelerating the flow.

The outer collar edge 33 and the outer lying edges 34 of the air guiding combs 22 and 23 are provided at the same distance from the rotor axis 3.

When the approach direction of the wind turns and the wind thus hits in a sloped manner to the rotor axis direction, the collar 26 and the respective end cover 30 capture the wind. These end covers 30 are provided with sloped slits 31 in the direction of rotation of the rotor, which extend between rotor axis 3 and the outer turbine edge 32.

The air flowing in through the slits 31 from the head side 29 hits the guiding blades 4 and the first third of the rotating vanes. As shown in FIG. 6, full air access to the rotating vanes 2 is impeded by means of a check plate 35 partially covering rotating cylinder 2a. The air entering through slits 31 of end cover 30 can also be used to drive rotating cylinder 2a.

1. Wind turbine for utilizing the energy contained in an air flow comprising:
an inner rotating cylinder (2a), which has rotating vanes (2) supplied with air, which rotate around a rotor axis (3) and drive it,
a stationary guiding cylinder (4a) surrounding the rotating cylinder (2a), having guiding blades (4) not rotating around the rotor axis (3), which guide the air flow fed to them to the rotating vanes (2) of the rotating cylinder (2a),
capturing vanes (5), which are directed at its guiding blades (4) outside the guiding blades (4) of the stationary guiding cylinder (4a),
wherein the capturing vanes (5) belong to a pivoting cylinder (5a), with which they are pivotable into a capturing position determined by the wind direction, and
wherein the outer end edges (8) of the capturing vanes (5) are staggered at least partially in the approach direction from front to back from capturing vane (5) to capturing vane (5) and the outer end edges (8) of the capturing vanes (5) from capturing vane (5) to capturing vane (5) are arranged projecting further laterally so that the capturing vanes (5) capture subflows (5,12 to 5,56) of the oncoming air flow associated therewith and divert them to the guiding blades (4) and seen in the approach direction, the even more elongated final capturing vanes (5,6) in terms of area and elongation are located behind the next to the last capturing vanes (5,5), wherein the rotating cylinder (2a), the guiding cylinder (4a) and the pivoting cylinder (5a) are grouped around the rotor axis (3) of the device.

2. The device according to claim 1, wherein the final capturing vanes (5,6) have tips projecting forward against the wind direction and the tips of the final capturing vanes project forward over the tips of the respectively next capturing vane (5,56).

3. The device according to claim 1, wherein seen in the approach direction the inner ends of the final capturing vanes (5,6) are located approximately at a width angle of the guiding cylinder of 250° to 350° or the final capturing vanes are even aligned parallel with each other and/or independently of this the capturing vanes (5) on both sides of the cylinder curvature approached by the air flow have the same or different alignments with respect to the air flow.

4. The device according to claim 1, wherein the distance of the capturing vane ends with respect to the capturing vane tips on the capturing vane ends from capturing vane to capturing vane calculated with the aid of parallel lines to the approach direction through the capturing vane tips from front to back becomes smaller, with the exception of the final capturing vane.

5. The device according to claim 1, wherein at least one, in the case of symmetrical design of the final capturing vanes both, of the forward-projecting tips of a final capturing vane project over the approached transverse axis, which runs through the rotor axis (3) and is located at a right angle to the wind direction, while a total of at least two subsequent capturing vanes do not do this.

6. Cylindrical wind turbine for utilizing the energy contained in an air flow with a horizontally running rotor axis (3) of the wind turbine, wherein the wind turbine is installed on a roof ridge, having
an internal rotating cylinder (2a), which has rotating vanes (2) supplied with air, which rotate around a rotor axis (3) and drive it,
a stationary guiding cylinder (4a) surrounding the rotating cylinder (2a), having guiding blades (4) not rotating around the rotor axis (3), which guide the air flow fed to them to the rotating vanes (2) of the rotating cylinder (2a),
stationary capturing vanes (5), which are directed at its guiding blades (4) outside the guiding blades (4) of the stationary guiding cylinder (4a),
wherein the outer end edges of the capturing vanes (5) in the approach direction staggered at least partially from front to back end further laterally projecting upwards or respectively downwards from capturing vane (5) to capturing vane (5), and
with at least one pivotable air guiding comb (22,23), which is pivotable further backward above and/or below the capturing vanes (5), respectively relative to the horizontal rotor axis (3) in the area of the largest curvature (36) of the pivoting cylinder in the approach direction (A) in the case of increasing pressure of the approaching air flow in the approach direction.

7. The device according to claim 6, wherein the capturing vanes (5k) in the area run over by the air guiding combs (22,23) have an even projection and/or wherein the capturing vanes (5) on both sides of the cylinder curvature (36) approached by the air flow have the same alignments with respect to the air flow.

8. The device according to at claim 6, wherein the air guiding combs (22,23) are designed such that they automatically pivot into a vertical position in the case of a low oncoming air flow by means of return mechanisms and pivot backwards pushed by it in the case of an increasing air flow.

9. The device according to claim 6, wherein the maximum deviation of the air guiding combs (22,23) backwards is measured at 220° to 300° angle degrees.

10. The device according to claim 6, wherein a collar (26) extends around it approximately at ¼ to ¾ of the length, in particular approximately half the length, of the cylindrical wind turbine.

11. The device according to claim 10, wherein the outer collar edge (33) of the collar (26) and the outer lying edges (34) of the air guiding combs (22,23) are arranged at the same distance from the rotor axis (3).

12. The device according to claim 10, wherein the cross-section (27) of the collar (26) corresponds with the cross-section of a drop, the tip (27a) of which points towards the rotor axis (3).

13. The device according to claim 6, wherein a stationary, roof-shaped air capturing comb (24) is provided above the upper air guiding comb (23).

14. The device according to claim 1, wherein a connection line (6b) between the outer end edges (6a) and inner end edges (6) respectively of a rotating vane (2) of the rotating cylinder (2a), where the approaching air hits, with the connection line (11) between the outer end edge 6a and rotor axis (3) includes angles between c1 equaling −20° and c2 equaling +30°.

15. The device according to one or more of the previous claims claim 1, wherein the inner neighboring end edges (6) of the rotating vanes (2) seen from the rotor axis (3) lie apart at an angle d between 5° to 35°.

16. The device according to claim 1, wherein the outer end surfaces (14) of the guiding blades (4) with the intended connection line (15) between outer end surface (14) and rotor axis (3) include an angle between e1 equaling −30° and e2 equaling −65°.

17. The device according to one or more of the previous claims, characterized in that the inner lying air outlet edges (12) of the guiding blades (4) seen from the rotor axis (3) lie apart at an angle f of 5° to 35°.

18. The device according to claim 1, wherein the inner lying air outlet edges (16) of the capturing vanes (5) from an air outlet edge (16) to the neighboring air outlet edge (16) and the outer lying air inlet edges (17) of the capturing vanes (5) from an air inlet edge (17) to the neighboring air inlet edge (17) measured from the rotor axis (3) respectively lie apart at an angle h of 5° to 35°.

19. The device according to claim 1, wherein the rotating vanes (2) have the shape of a helix.

20. The device according to claim 19, wherein the helix, in particular in the area between ⅓ and ⅔ of the rotor axis (3), is mirrored on a mirror plane approximately at a 90° angle to the rotor axis (3), in order to divert the wind proportionately in both directions of the rotor axis (3).
